(19) United States
(12) Patent Application Publication
(10) Pub. No.: US 2014/0143597 A1
(43) Pub. Date: May 22, 2014

(54) COMPUTER SYSTEM AND OPERATING METHOD THEREOF

(71) Applicants: INVENTEC (PUDONG) TECHNOLOGY CORPORATION, Shanghai (CN); INVENTEC CORPORATION, Taipei City (TW)

(72) Inventor: Chia-Hsiang Chen, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/793,898

(22) Filed: Mar. 11, 2013

(30) Foreign Application Priority Data
Nov. 20, 2012 (CN) 201210470105.4

(51) Int. Cl. G06F 11/07

(52) U.S. Cl. CPC G06F 11/0793
USPC 714/15

(57) ABSTRACT

A computer system and an operating method thereof are disclosed herein. The computer system includes at least one monitored device and a logic control device. The logic control device is connected to the monitored device, and is configured to monitor status signals from the monitored device so as to determine whether the monitored device is in an error state. When the monitored device is in the error state, the logic control device monitors a predetermined time period, and determines whether the monitored device recovers to normal after the predetermined time period, and determines whether the monitored device has been reset during the predetermined time period. If the monitored device does not recover to normal and the monitored device has not been reset during the predetermined time period, then the logic control device resets the monitored device.

### RELATED APPLICATIONS

This application claims priority to Chinese Application Serial Number 201210470105.4, filed Nov. 20, 2012, which is herein incorporated by reference.

### BACKGROUND

1. Field of Invention

The invention relates to an electronic system and an operating method thereof. More particularly, the invention relates to a computer system and an operating method thereof.

2. Description of Related Art

With the development of digital technology, a computer system has been widely used in people's life, such as a desktop computer and a notebook computer for personal use, and a network processor and a server for providing a network service.

Generally, the computer system includes multiple devices which are operated separately, such as, a central processing unit, a south bridge chip, a storage device, and a basic input output system. When these devices are in an error state, an error signal is transmitted to a management controller (such as a baseboard management controller) in the computer system to enable the management controller to restart these devices. However, the management controller may also be in the error state or in a failed state so that the management controller does not restart these devices when these devices are in the error state. As a result, the computer system may be in an error state for a long time. If the computer system is a server providing a network service, then degradation of the network service quality may result causing further user dissatisfaction.

Therefore, in order to ensure the reliable error recovery of the computer system, there is an urgent need to solve the above-mentioned issue.

### SUMMARY

An aspect of the invention provides a computer system which uses a logic control device to monitor signals and perform an error recovery.

According to an embodiment of the invention, the computer system includes at least one monitored device and a logic control device. The logic control device is connected to the monitored device, and is configured to monitor status signals from the monitored device so as to determine whether the monitored device is in an error state. When the monitored device is in the error state, the logic control device monitors a predetermined time period, and determines whether the monitored device recovers to normal after the predetermined time period, and determines whether the monitored device has been reset during the predetermined time period. If the monitored device does not recover to normal and the monitored device has not been reset during the predetermined time period, then the logic control device resets the monitored device.

According to an embodiment of the invention, the logic control device further includes a status mapping table. The logic control device stores the status signals from the monitored device into corresponding addresses in the status mapping table as correct operation data.

According to an embodiment of the invention, the logic control device compares the status signals from the monitored device with the correct operation data stored in the corresponding addresses in the status mapping table so as to determine whether the monitored device is in the error state.

According to an embodiment of the invention, the logic control device further includes a timer configured to monitor a predetermined time period.

According to an embodiment of the invention, the logic control device determines whether the monitored device is in the error state according to whether a normal signal transmitted from the monitored device is not received or whether a fault signal is transmitted from the monitored device.

According to an embodiment of the invention, the logic control device restarts a main power rail such that the monitored device is restarted.

Another aspect of the invention provides an operating method of a computer system. According to an embodiment of the invention, the computer system includes a logic control device and at least one monitored device. The logic control device is connected to the monitored device. The operating method includes: monitoring status signals from the monitored device; determining whether the monitored device is in an error state according to the status signals from the monitored device; when the monitored device is in the error state, monitoring a predetermined time period; determining whether the monitored device recovers to normal after the predetermined time period, and determining whether the monitored device has been reset during the predetermined time period; and if the monitored device does not recover to normal and the monitored device has not been reset during the predetermined time period, then resetting the monitored device.

According to an embodiment of the invention, the logic control device includes a status mapping table. The step of determining whether the monitored device is in the error state according to the status signals from the monitored device includes: storing the status signals from the monitored device into corresponding addresses in the status mapping table as correct operation data; and then, comparing the status signals from the monitored device with the correct operation data stored into the corresponding addresses in the status mapping table so as to determine whether the monitored device is in the error state.

According to an embodiment of the invention, the step of determining whether the monitored device is in the error state according to the status signals from the monitored device includes: determining whether the monitored device is in the error state according to whether a normal signal transmitted from the monitored device is not detected or whether a fault signal is transmitted from the monitored device.

According to an embodiment of the invention, the step of resetting the monitored device includes: restarting a main power rail such that the monitored device is restarted.

In view of the above, by applying the above-mentioned embodiments, when an internal device of the computer system is in an error state, the internal device can be recovered to normal through the logic control device. Since the logic control device can be realized by a logic element which is less error-prone, a reliable error recovery mechanism can be provided.

### BRIEF DESCRIPTION OF THE DRAWINGS

FIG. 1 is a block diagram of a computer system illustrated according to an embodiment of the invention; and

FIG. 2 is a flow chart of an operating method of a computer system illustrated according to an embodiment of the invention.

### DETAILED DESCRIPTION

The spirit of the disclosure will be described in details with reference to the accompanying drawings and detailed description as follows. After those skilled in the art learn the embodiments of the disclosure, with the technology taught in the disclosure, modifications and variations can be made without departing from the spirit and scope of the disclosure.

For the phrase “connection” used herein, it may refer to the physical contact or electrical contact between two or more elements directly or indirectly. However, the phrase “connection” also may refer to the interoperation or interaction between two or more elements.

An aspect of the invention provides a computer system which uses a logic control device to monitor signals and perform an error recovery. The computer system may be a desktop computer, a notebook computer, a network processor, a server and so on. For the purpose of clear description, the server will be taken as an example in the following paragraphs.

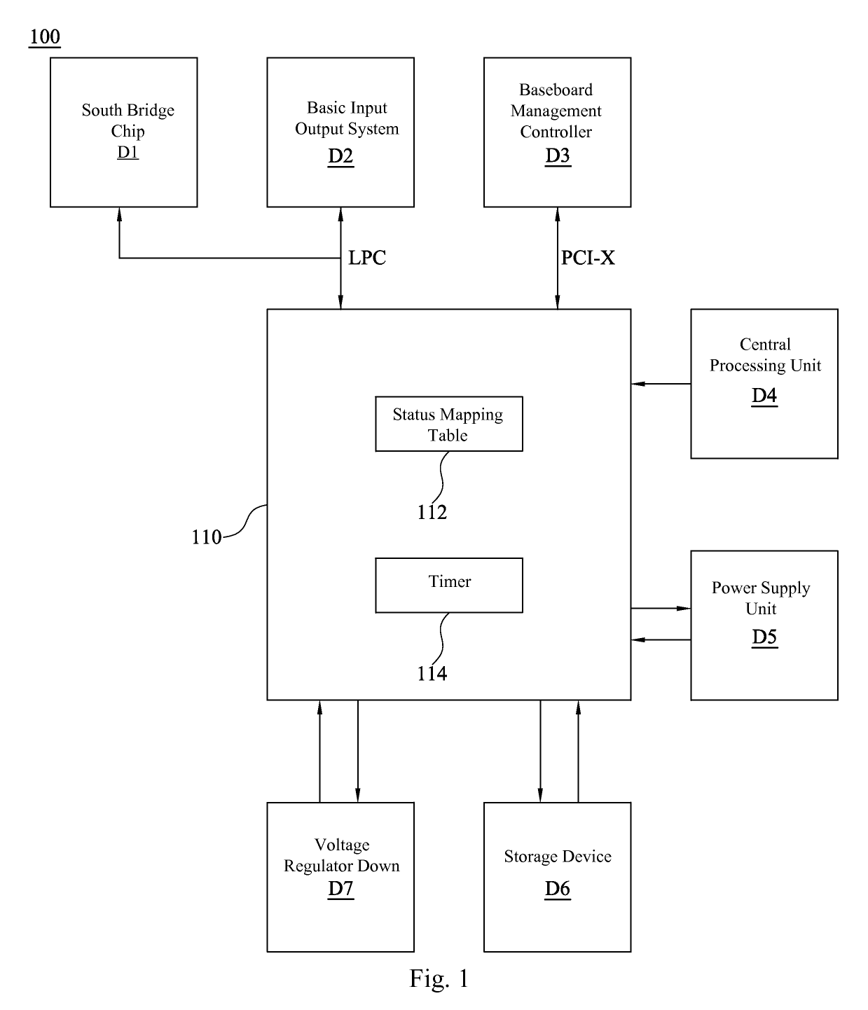

FIG. 1 is a block diagram of a computer system 100 illustrated according to an embodiment of the invention. The computer system 100 includes at least one monitored device (e.g., seven monitored devices D1-D7) and a logic control device 110. It should be noted that, the monitored device may be an internal device of the computer system 100, including but not limited to any one of a south bridge chip, a basic input output system (BIOS), a baseboard management controller (BMC), a central processing unit (CPU), a power supply unit (PSU), a storage device and a voltage regulator down (VRD). For the purpose of clear description, seven monitored devices D1-D7 are taken as examples for description in the following paragraphs. D1 may be a south bridge chip; D2 may be a BIOS; D3 may be a BMC; D4 may be a CPU; D5 may be a PSU; D6 may be a storage device; and D7 may be a VRD. The logic control device 110 can be realized by (but not limited to) a logic circuit, a programmable logic device (PLD), a complex programmable logic device (CPLD) or a field programmable gate array (FPGA).

The logic control device 110 is connected to each of the monitored devices D1-D7 and is configured to monitor status signals from the monitored devices D1-D7 so as to determine whether the monitored devices D1-D7 are in an error state. For example, the logic control device 110 can monitor whether the south bridge chip D1 and the BIOS D2 transmit a normal signal (such as a heartbeat signal) through a low pin count (LPC) bus, monitor whether the BMC D3 transmits a normal signal (such as a heartbeat signal) through a peripheral component interconnect extended (PCI-X) bus and monitor whether the CPU D4 transmits an overheating signal or a fault signal (such as CPU_ierr, CPU_mcerr and Thermal_trip), whether the PSU D5 transmits an overheating signal and/or a normal signal (such as a power good signal) and whether the storage device D6 and the VRD D7 transmit a fault signal and/or a normal signal (such as a power fault signal and/or a power good signal) through general purpose input/output (GPIO) pins. Furthermore, since the VRD D7 can output multiple voltage levels to each internal devices of the computer system 100, the logic control device 110 can monitor a fault signal and/or a normal signal of each voltage level outputted from the VRD D7. In such a way, by monitoring the fault signals and/or normal signals from the monitored devices D1-D7, the logic control device 110 can determine whether the monitored devices D1-D7 are in the error state according to whether the normal signals transmitted from the monitored devices D1-D7 are not detected or whether the fault signals are transmitted from the monitored devices D1-D7.

When the monitored devices D1-D7 are in the error state, the logic control device 110 monitors a predetermined time period, and determines whether the monitored devices D1-D7 recover to normal after the predetermined time period (e.g., whether the normal signals are received again or the fault signals are canceled), and determines whether the monitored devices D1-D7 have been reset during the predetermined time period. For example, the logic control device 110 can use multiple GPIO pins to monitor multiple voltage levels outputted from the VRD D7 or the power good/fault signals of multiple voltage levels outputted from the VRD D7 and determine whether the monitored devices D1-D7 have been reset according to whether these voltage levels are restarted (e.g., whether these voltage levels being turned on after being turned off first).

Accordingly, if the monitored devices D1-D7 do not recover to normal and the monitored devices D1-D7 have not been reset during the predetermined time period, the logic control device 110 resets the monitored devices D1-D7. For example, the logic control device 110 can reset a single one of the monitored devices D1-D7 by transmitting a reset signal to the monitored devices D1-D7 or restart a main power rail such that the computer system 100 is restarted.

Through the above-mentioned configuration, the logic control device 110 can monitor the status of the monitored devices D1-D7 and restart the computer system 100 or a single one of the monitored devices D1-D7 which is in the error state when the monitored devices D1-D7 do not recover to normal or have not been reset from the error state, so as to ensure the correct operation of the computer system 100. In addition, since the logic control device 110 can be realized by a logic element, compared with a management controller of higher level (such as BMC), the logic control device 110 can provide a more reliable error recovery mechanism.

In an embodiment of the invention, the logic control device 110 can further include a status mapping table 112. During operation of the computer system 100, the logic control device 110 can store the status signals from the monitored devices D1-D7 into corresponding addresses of the status mapping table 112 as correct operation data. For example, a logic voltage level received by a first GPIO pin can be stored into a first address in the status mapping table 112. A logic voltage level received by a second GPIO pin can be stored into a second address in the status mapping table 112. A logic voltage level received by a first pin of the LPC bus can be stored into a third address in the status mapping table 112. It should be noted that, in some embodiments, each address in the status mapping table 112 can point to multiple register spaces so as to store status signals at different times or store periodic status signals (such as the heartbeat signal).

After acquiring the correct operation data, the logic control device 110 compares the status signals from the monitored devices D1-D7 received currently with the correct operation data previously stored in the corresponding addresses in the status mapping table 112 so as to determine whether the monitored devices D1-D7 are in the error state. Similarly, in this way, the logic control device 110 also can determine whether the monitored devices D1-D7 recover to normal from the error state. For example, if the overheating signal (such as Thermal_trip) from the CPU D4 stored in the second address of the status mapping table 112 is at a high logic voltage level, then when the logic control device 110 finds out that the overheating signal from the CPU D4 received by the second GPIO pin is at a low logic voltage level, the logic control device 110 can accordingly determine that the CPU D4 is in the error state.

It should be noted that, in other embodiments, the logic control device 110 also can compare the status signals from the monitored devices D1-D7 with values predetermined by administrators so as to determine whether the monitored devices D1-D7 are in the error state. The determination method is not limited to the above-mentioned embodiments.

In some embodiments, the logic control device 110 also can determine possible errors on the whole according to a plurality of status signals from the monitored devices D1-D7.

Additionally, in an embodiment of the invention, the logic control device 110 can further include a timer 114 configured to monitor and determine the above-mentioned predetermined time period.

Additionally, without departing from the spirit of the invention, those skilled in the art should understand that the status signals from the monitored devices D1-D7 may be any signals indicating whether the monitored devices D1-D7 are operated normally, although the invention is not limited to the signals in the above-mentioned embodiments.

Another aspect of the invention provides an operating method of a computer system. This operating method can be applied to a computer system which has a structure the same as or similar to that of the computer system of FIG. 1 described above. For the convenience of description, the embodiment shown by FIG. 1 is taken as an example to describe the following operating method, although the invention is not limited to the embodiment of FIG. 1.

It should be noted that, in the steps of the following operating method, no particular sequence is required unless otherwise specified. Moreover, the following steps also may be performed simultaneously or may be overlapped in the execution time.

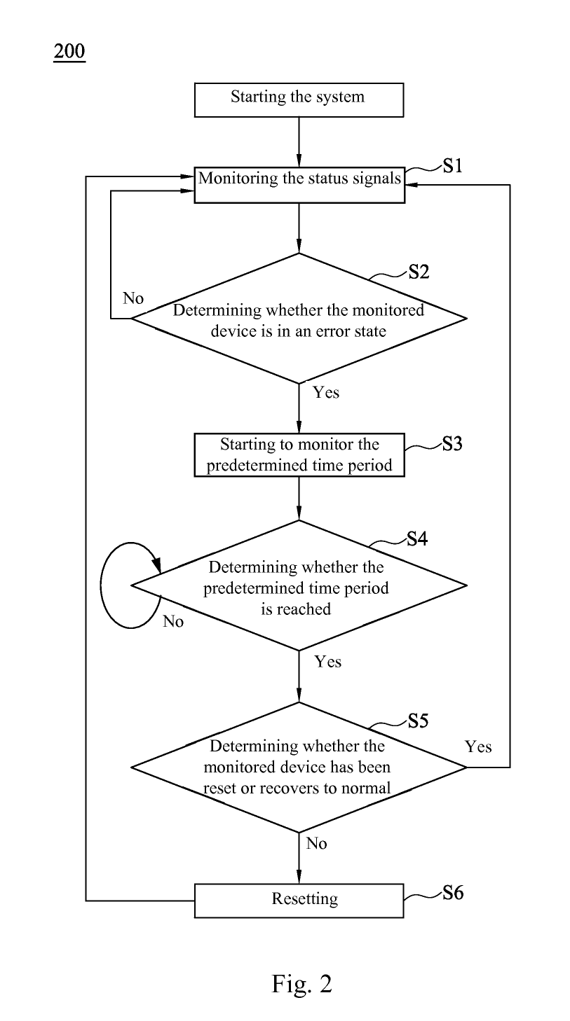

FIG. 2 is a flow chart of an operating method 200 illustrated according to an embodiment of the invention. The operating method 200 may include steps S1-S5. After the computer system 100 is started, status signals from the monitored devices D1-D7 are monitored (the step S1), and according to the status signals from the monitored devices D1-D7, whether the monitored devices D1-D7 are in an error state is determined (the step S2). When the monitored devices D1-D7 are in the error state, a predetermined time period is started to be monitored (the step S3), and then a determination is performed to determine whether the predetermined time period is reached (the step S4). After the predetermined time period is reached, whether the monitored devices D1-D7 recover to normal is determined, and whether the monitored devices D1-D7 have been reset during the predetermined time period is determined (the step S5). If the monitored devices D1-D7 do not recover to normal and the monitored devices D1-D7 have not been reset during the predetermined time period, then the monitored devices D1-D7 are reset (the step S6).

For the detailed description of the monitored devices D1-D7, the previous aspect can be referred to and thus it will not be further described herein.

For the examples in implementation, at the step S1, the computer system 100 can monitor whether the south bridge chip D1, the BIOS D2 and the BMC D3 transmit normal signals (such as a heartbeat signal), whether the CPU D4 transmits an overheating signal or a fault signal (such as CPU_ierr, CPU_mcerr and Thermal_trip), whether the PSU D5 transmits an overheating signal and/or a normal signal (such as a power good signal) and whether the storage device D6 and the VRD D7 transmit fault signals and/or normal signals (such as a power fault signal and/or a power good signal). The computer system 100 can separately monitor a fault signal and/or a normal signal of each voltage level outputted from the VRD D7.

At the step S2, the computer system 100 can determine whether the monitored devices D1-D7 are in the error state according to whether the normal signals transmitted from the monitored devices D1-D7 are not detected or whether the fault signals are transmitted from the monitored devices D1-D7. Additionally, if the monitored devices D1-D7 are not in the error state, the computer system 100 performs the step S1 again so as to continue to monitor the status signals from the monitored devices D1-D7.

At the step S3, the computer system 100 can use a timer to monitor the predetermined time period. In some embodiments, the computer system 100 can continue to monitor the status signals from the monitored devices D1-D7 during the predetermined time period so as to determine whether other errors still exist or occur and then further determine possible errors on the whole.

At the step S5, the computer system 100 can determine whether the monitored devices D1-D7 recover to normal according to whether the normal signals are received again or the fault signals are canceled. The computer system 100 can separately monitor multiple voltage levels outputted from the VRD D7 or the power good/fault signals of multiple voltage levels outputted from the VRD D7 and determine whether the monitored devices D1-D7 have been reset according to whether these voltage levels are restarted (e.g., whether these voltage levels being turned on after being turned off first). If the computer system 100 determines that the monitored devices D1-D7 recover to normal or have been reset, then it indicates that the monitored devices D1-D7 may have been processed by other error recovery mechanisms. Therefore, the computer system 100 can perform the step S1 again so as to continue to monitor the status signals from the monitored devices D1-D7.

At the step S6, the computer system 100 can reset a single one of the monitored devices D1-D7 by transmitting a reset signal to the monitored devices D1-D7 or restart a main power rail so as to enable the monitored devices D1-D7 in the computer system 100 to be restarted.

Through the above-mentioned configuration, the computer system 100 can monitor the status of the monitored devices D1-D7 and restart all the monitored devices D1-D7 or restart the single one of the monitored devices D1-D7 which is in the error state when the monitored devices D1-D7 do not recover to normal or have not been reset from the error state, so as to ensure the correct operation of the computer system 100.

In an embodiment of the invention, the step S2 may include the following sub-steps: (a) storing the status signals from the monitored devices D1-D7 into the corresponding addresses in the status mapping table 112 as the correct operation data; and then (b) comparing the status signals from the monitored devices D1-D7 with the correct operation data stored into the corresponding addresses of the status mapping table 112 so as to determine whether the monitored devices D1-D7 are in the error state.

For example, the computer system 100 can store the logic voltage level of the overheating signal (such as Thermal_trip) of the CPU D4 into the second address in the status mapping table 112 as the correct operation data of the computer system 100. Then, the computer system 100 can compare whether the received overheating signal from the CPU D4 and the logic voltage level stored in the second address in the status mapping table 112 are the same so as to determine whether the CPU D4 is in the error state.

Additionally, in some embodiments, the computer system 100 also can use the correct operation data stored into the status mapping table 112 to determine whether the monitored devices D1-D7 recover to normal from the error state.

It should be noted that, in other embodiments, the computer system 100 also can compare the status signals from the monitored devices D1-D7 with values predetermined by administrators so as to determine whether the monitored devices D1-D7 are in the error state. The method for determining errors is not limited to the above-mentioned embodiments.

Although the invention has been disclosed with reference to the above embodiments, these embodiments are not intended to limit the invention. It will be apparent to those skilled in the art that various modifications and variations can be made without departing from the spirit and scope of the invention. Therefore, the scope of the invention shall be defined by the appended claims.

What is claimed is:

1. A computer system, comprising:
at least one monitored device; and
a logic control device, connected to the monitored device and configured to monitor status signals from the monitored device so as to determine whether the monitored device is in an error state, wherein when the monitored device is in the error state, the logic control device monitors a predetermined time period, determines whether the monitored device recovers to normal after the predetermined time period, and determines whether the monitored device has been reset during the predetermined time period, wherein if the monitored device does not recover to normal and the monitored device has not been reset during the predetermined time period, then the logic control device resets the monitored device.

2. The computer system of claim 1, wherein the logic control device further comprises a status mapping table, and the logic control device stores the status signals from the monitored device into corresponding addresses in the status mapping table as correct operation data.

3. The computer system of claim 2, wherein the logic control device compares the status signals from the monitored device with the correct operation data stored in the corresponding addresses in the status mapping table so as to determine whether the monitored device is in the error state.

4. The computer system of claim 1, wherein the logic control device further comprises a timer configured to monitor the predetermined time period.

5. The computer system of claim 1, wherein the logic control device determines whether the monitored device is in the error state according to whether a normal signal transmitted from the monitored device is not received or whether a fault signal is transmitted from the monitored device.

6. The computer system of claim 1, wherein the logic control device restarts a main power rail such that the monitored device is restarted.

7. An operating method of a computer system, wherein the computer system comprises a logic control device and at least one monitored device, and the logic control device is connected to the monitored device, and the operating method comprises:
monitoring status signals from the monitored device;
determining whether the monitored device is in an error state according to the status signals from the monitored device;
monitoring a predetermined time period when the monitored device is in the error state;
determining whether the monitored device recovers to normal after the predetermined time period, and determining whether the monitored device has been reset during the predetermined time period; and
resetting the monitored device if the monitored device does not recover to normal and the monitored device has not been reset during the predetermined time period.

8. The operating method of claim 7, wherein the logic control device comprises a status mapping table, and the step of determining whether the monitored device is in the error state according to the status signals from the monitored device comprises:
storing the status signals from the monitored device into corresponding addresses in the status mapping table as correct operation data; and
comparing the status signals from the monitored device with the correct operation data stored in the corresponding addresses in the status mapping table so as to determine whether the monitored device is in the error state.

9. The operating method of claim 7, wherein the step of determining whether the monitored device is in the error state according to the status signals from the monitored device comprises:
determining whether the monitored device is in the error state according to whether a normal signal transmitted from the monitored device is not detected or whether a fault signal is transmitted from the monitored device.

10. The operating method of claim 7, wherein the step of resetting the monitored device comprises:
restarting a main power rail such that the monitored device is restarted.
